(19) United States
(12) Patent Application Publication
(10) Pub. No.: US 2024/0133300 A1
(43) Pub. Date: Apr. 25, 2024

(54) ASSEMBLY FOR A TURBOMACHINE BLADE, COMPRISING A FASTENER, DEFINING A POCKET, AND A SHIM ADAPTED TO BE RECEIVED IN THE POCKET AT THE SAME TIME AS A ROOT OF THE BLADE

(71) Applicant: SAFRAN AIRCRAFT ENGINES, Paris (FR)

(72) Inventors: Vivien Mickaël COURTIER, MOISSY-CRAMAYEL (FR); Christophe Paul JACQUEMARD, MOISSY-CRAMAYEL (FR); Vincent JOUDON, MOISSY-CRAMAYEL (FR)

(73) Assignee: SAFRAN AIRCRAFT ENGINES, Paris (FR)

(21) Appl. No.: 17/769,617

(22) PCT Filed: Oct. 15, 2020
(86) PCT No.: PCT/FR2020/051867

§ 371 Date: Apr. 14, 2022

(30) Foreign Application Priority Data
Oct. 17, 2019 (FR) 1911661

(51) Int. Cl. F01D 5/30; B64C 11/06; F01D 5/32; F01D 7/00

(52) U.S. Cl. CPC F01D 5/3007; B64C 11/06; F01D 5/326; F01D 7/00; F05D 2220/36

(57) ABSTRACT

Assembly for a turbomachine blade, comprising: a fastener (9) defining a pocket (10) for receiving a blade root (11), and comprising two flanks defining between them a passage leading into the pocket (10) and forming stops preventing the root (11) from exiting from the pocket (10) via the passage, a shim (26a, 26b) adapted to be received in the pocket (10) with the root (11), the shim (26a, 26b) having a first support surface (28a, 28b) to bear on the root (11) and a second support surface (30a, 30b) opposite the first support surface (28a, 28b) to bear against the fastener (9), the support surfaces being fixed relative to each other and oriented such that movement of the shim (26a, 26b) in the pocket (10) relative to the fastener (9) varies the value of force exerted by the shim (26a, 26b) on the root (11).

### FIELD OF THE INVENTION

The present invention relates to an assembly of pieces serving to fasten a blade to an aircraft engine rotor, especially a non-ducted fan rotor (such as an engine of ‘Open Rotor’ type having two turning helices or an engine of USF type for ‘Unducted Single Fan’ having mobile blading and fixed blading or a turboprop having an architecture with a single helix).

### PRIOR ART

The interest in unducted fan engines is that the diameter of the fan is not limited by the presence of fairing, making it possible to design an engine having a high dilution ratio, and consequently reduced fuel consumption.

Therefore, in this type of engine the blades of the fan can exhibit a large scale.

Such non-ducted fans conventionally comprise a blade fastener defining a pocket for receiving a root of a blade. The blade fastener comprises two opposite flanks defining between them a passage leading into the pocket and forming stops preventing the root from exiting from the pocket via the passage.

Also, these engines generally comprise a mechanism for modifying the shimming angle of the blades to adapt the thrust generated by the fan as a function of the different flight phases.

However, designing such blades needs to take into account conflicting constraints.

On one hand, the sizing of these blades must allow optimal aerodynamic performance (maximising yield and providing thrust, and minimising losses). The improvement in aerodynamic performance of the fan tends towards an increase in the rate of increase of the dilution ratio (BPR, for bypass ratio), which is reflected in an increase in the external diameter and therefore in the scale of these blades.

On the other hand, it is also necessary to guarantee resistance to mechanical constraints which can be applied to these blades and limit their acoustic signature.

Also, for unducted fan architectures, the starting of the engine is generally done via very open shimming. In fact, very open shimming consumes power by the couple, ensuring safety of the machine by guaranteeing low fan speeds.

Now, with very open shimming the blades undergo turbulent aerodynamic flow, completely detached, which generates broadband vibratory excitation. In particular on wide-chord and large-scale blades the force flexion is intense even though the engine speed is not maximal.

Due to this vibratory excitation, the blade root is able to flutter in the leading pocket in which this root is received. Yet, such fluttering risks damaging the blade or the fastener itself.

The problems set out hereinbelow could also show up in the case of a ducted engine which would comprise variable shimming of the fan blades.

It has been proposed to incorporate into a fan a deformable shim forcibly interposed in the pocket between the blade root and the fastener. Such a deformable shim further clamps the blade root in the pocket of the fastener, resulting in reducing of the fluttering phenomenon described earlier.

Yet, such a deformable shim is not capable of effectively eliminating this fluttering phenomenon in blades with variable-pitch fans and wide-chord and/or large-scale fans, where there are particularly intense aerodynamic forces even at low fan speeds.

### SUMMARY OF THE INVENTION

An aim of the present invention is to improve resistance to damage of blade or pocket feet in non-ducted wide-chord and/or large-scale fans.

An assembly for a turbomachine blade is therefore proposed, the assembly comprising:
a fastener defining a pocket for receiving a blade root, the fastener comprising two flanks defining between them a passage leading into the pocket and forming stops preventing the root from exiting from the pocket via the passage,
two shims, each shim comprising:
   a first support surface to bear on the root
   a second support surface opposite the first support surface to bear against the fastener when the shim is received in the pocket,
   a thread,
wherein the respective first and second support surfaces of the two shims are:
   fixed relative to each other,
   oriented such that movement of one of the two shims in the pocket relative to the other shim varies the sum of the forces exerted by the two shims on the root,
a tightening screw cooperating with the respective threads of the two shims such that rotation of the tightening screw causes movement of one of the two shims relative to the other shim.

The fact that the first support surface and the second support surface of each shim are fixed relative to each other allows to apply a much greater clamping force on the blade root, especially at low fan speeds, compared to a deformable shim.

Also, since movement of the shim in the pocket relative to the fastener varies the value of the force exerted by the shim on the root, the same shim can advantageously adapt to any manufacturing dispersions of the pocket.

The proposed assembly can also comprise the following optional characteristics, taken singly or combined whenever technically possible.

Preferably, the fastener has a base surface against which the second support surface of one of the two shims bears when the shim is received in the pocket, and wherein a surface from among the second support surface and the base surface has a rectilinear profile from among the second support surface and the base surface in a plane parallel to a direction of insertion of the blade root into the pocket, and the other surface has a convex curved profile in said plane.

Preferably, the surface having a convex curved profile is the second support surface.

Preferably, the assembly comprises a locking device configured to lock at least one of the two shims in different positions relative to the fastener, the sum of the forces exerted by the two shims on the root having different values in the different positions.

Preferably, the locking device comprises the tightening screw and the threads.

Preferably, the locking device comprises a sleeve in which one of the threads is formed, wherein one of the two shims defines a cavity containing the sleeve and is adapted for blocking the sleeve relative to the shim in a direction parallel to an axis of rotation of the tightening screw and for allowing some play of the sleeve relative to the shim in a radial direction relative to the axis of rotation of the tightening screw.

Preferably, the locking device comprises an anti-rotation system preventing the tightening screw from being set in rotation in a direction causing a decrease in the sum of the forces exerted by the two shims on the root.

Preferably, the tightening screw comprises a head arranged to terminate outside the pocket and the locking device so that it can be clamped and set in rotation by a tool, when the two shims are received in the pocket.

Preferably, the fastener defines two opposite accesses allowing introduction of the root and the two shims in the pocket, and wherein the locking device comprises two locks which the tightening screw passes through, the locks being arranged to prevent the two shims from exiting from the pocket via the opposite accesses when the tightening screw is set in rotation.

Preferably, the fastener has two base surfaces against which the second support surfaces of the two shims respectively bear when the two shims are received in the pocket, wherein the second support surfaces have different slopes, and wherein the base surfaces have different slopes.

Preferably, at least one of the two shims is metallic, for example titanium.

An unducted fan is also proposed, for example variable-pitch, comprising the assembly discussed hereinabove.

### DESCRIPTION OF THE FIGURES

Other characteristics, aims and advantages of the invention will emerge from the following description which is purely illustrative and non-limiting and which must be considered in conjunction with the appended drawings.

FIG. 1 schematically illustrates an example of an engine including an unducted fan.

FIG. 2 is a perspective view of a fastener intended to receive a blade root.

FIG. 3 is a side view of a clamping device comprising shims, according to an embodiment of the invention;

FIG. 4 is a view in longitudinal section of some pieces of the device shown in FIG. 3.

FIGS. 5, 6, 7 schematically illustrate profiles of some surfaces of the fastener of FIG. 2 and of the clamping device of FIGS. 3, 4, according to three different embodiments.

FIGS. 8, 9, 10 are perspective views of a fastener, a blade root and a clamping device according to an embodiment, at three different stages of their assembly.

In all figures, similar elements have identical reference numerals.

### DETAILED DESCRIPTION OF THE INVENTION

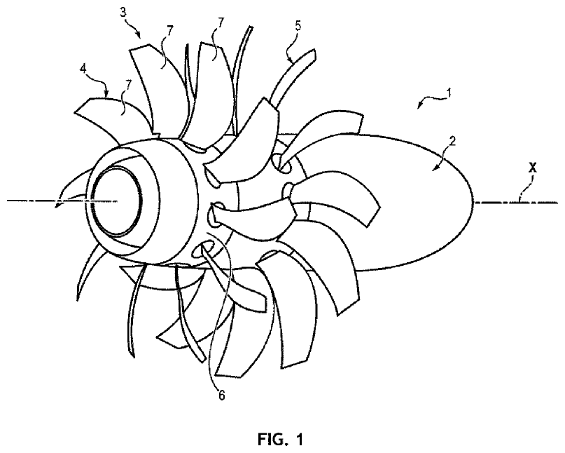

In FIG. 1, the engine 1 shown is an engine of ‘Open Rotor’ type, in a configuration currently qualified as ‘pusher’ (i.e. the fan is placed to the rear of the power generator with an air intake located to the side, to the right in FIG. 1).

The engine comprises a nacelle 2 intended to be fixed to a fuselage of an aircraft, and a non-ducted fan 3. The fan 3 comprises two counterrotating fan rotors 4 and 5. In other words, when the engine 1 is running the rotors 4 and 5 are set in rotation relative to the nacelle 2 around the same axis of rotation X (which coincides with a principal axis of the engine), in opposite directions.

In the example illustrated in FIG. 1, the engine 1 is an engine of ‘Open Rotor’ type, in ‘pusher’ configuration, having counterrotating fan rotors. However, the invention is not limited to this configuration. The invention also applies to engines of ‘Open Rotor’ type in ‘puller’ configuration (i.e. the fan is placed upstream of the power generator with an air intake located at the front, between or just behind the two fan rotors).

The engine can have a different architecture however, such as an architecture comprising a fan rotor comprising mobile blades and a fan stator comprising fixed blades, or else a single fan rotor.

The engine can have an architecture of turboprop type (comprising a single fan rotor).

The engine can be ducted and have two flows and wherein a variable-pitch fan feeds said flows, specifically the primary flow and the secondary flow in the engine.

In FIG. 1, each fan rotor 4, 5 comprises a hub 6 mounted to rotate relative to the nacelle 2 and a plurality of blades 7 fixed to the hub 6. The blades 7 extend substantially radially relative to the axis of rotation X of the hub.

In the present application, upstream and downstream are defined relative to the normal direction of flow of gas in the rotor 4, 5 and through the turbomachine. Also, axis X of the rotor 4, 5 is called its axis of rotation. The axial direction corresponds to the direction of the axis X and a radial direction is a direction perpendicular to this axis and passing through it. Also, the circumferential direction corresponds to a direction perpendicular to the axis X and not passing through it. Unless expressed otherwise, internal and external respectively are used in reference to a radial direction such that the internal part or the face of an element is closer to the axis X than the external part or the face of the same element.

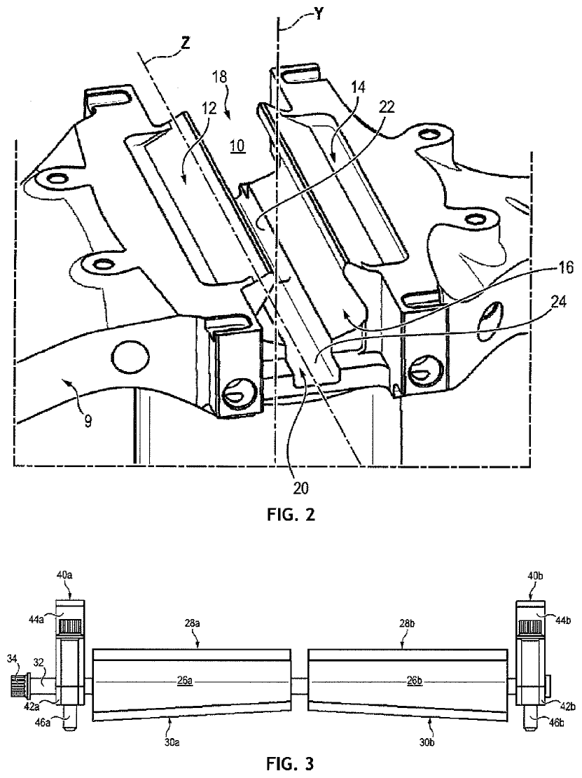

In reference to FIG. 2, for each blade 7 the fan 3 comprises a piece of fastener 9 or more simply fastener 9. The fastener 9 is mounted to rotate relative to the hub 6 around a shimming axis Y. More precisely, the fastener 9 is mounted to rotate inside a housing made in the hub 6, by means of balls or other rolling elements.

The fastener 9, which can bear the pivot name in the literature, defines a pocket 10 for receiving a root of the blade 7, the root having for example a form of a dovetail.

The fastener 9 comprises especially two flanks 12, 14 defining between them an upper radial opening of the pocket 10, opposite a base of the pocket 10. The two flanks 12, 14 are inclined towards each other and form spans.

The pocket 10 extends in a direction Z between two opposite accesses 16, 18 defined by the fastener 9.

One of the two accesses 16, 18 is off to the side of a leading edge of the blade, and the other access is off to the side of a trailing edge of the blade.

It is by way of one or the other of these opposite accesses 16, 18 that a blade root can be engaged in the pocket 10, by sliding.

The two flanks 12, 14 have surfaces leading into the cavity which are cylindrical (of which the generators are parallel to the axis Z).

The two flanks 12, 14 comprise two mutually opposite and parallel walls defining a groove 20 at the base of the pocket 10.

Unlike the surfaces of the flanks 12, 14, the base of the pocket 10 does not have a rectilinear profile in a plane parallel to the plane (Y, Z). Hereinbelow ‘sagittal’ profile will be the profile of a part of the fastener in a plane parallel to the plane (Y, Z).

The base of the pocket 10 comprises two base surfaces 22, 24 having different slopes (these slopes will be discussed in more detail later).

The two base surfaces are located in the groove 20 between the two access 16, 18.

The fastener is made of titanium.

In reference to FIG. 3, a clamping device comprises two shims 26a, 26b.

The shim 26a is adapted to be received in the pocket 10 at the same time as a blade root, between the root and the base of the pocket 10.

The shim 26a has a first support surface 28a to bear on a blade root received in the pocket 10, and a second bearing surface 30a opposite the first support surface 28a to bear against the fastener when the shim 26a is received in the pocket 10.

The first support surface 28a is fixed relative to the second support surface 28b. The shim is made of a single piece (monobloc) and is rigid.

The first support surface 28a and the second support surface 30a are oriented relative to each other such that movement of the shim 26a in the pocket 10 relative to the fastener 9 varies the value of force exerted by the shim 26a on the root, especially in a radial direction parallel to the axis Y.

The first support surface 28a is intended to bear against a lower free surface of the root. The first support surface 28a for example has a form complementary to this lower free surface of the root.

The first support surface 28a has a sagittal rectilinear profile so that it can bear on a root of which the free surface has an equally rectilinear sagittal profile.

Preferably, the shim 26a comprises a coating applied to its second support surface 28a aimed at reducing friction between the shim and the base of the pocket 10. This coating is for example made of amorphous carbon (Diamond-Like Carbon) which has the advantage of being both hard and flexible.

Similarly, the shim 26b has a first support surface 28b to bear on a blade root received in the pocket 10, and a second bearing surface 30b opposite the first support surface 28b to bear against the fastener when the shim 26b is received in the pocket 10.

The surfaces 28b, 30b have the same properties as the above surfaces 28a, 30a.

The second support surface 30a of the shim 26a is intended to bear against one of the base surfaces (for example the surface 20), while the second support surface 30b of the other shim 26b is intended to bear against the other base surface (for example the surface 22) or vice-versa.

The shims 26a, 26b are typically made of titanium.

The first support surfaces 28a, 28b and the second support surfaces 30a, 30b of the two shims 26a, 26b are also oriented such that movement of one of the shims in the pocket 10 relative to the other shim varies the sum of the radial forces exerted by the two shims on a blade root received in the pocket 10, especially in a direction parallel to the axis Y.

The fan 3 also comprises a locking device configured to lock at least one of the shims in different positions relative to the fastener, the force radial exerted by the shim on the root having different values in the different positions.

The locking device comprises a tightening screw 32.

The tightening screw 32 comprises a head 34 able to be clamped and set in rotation by a tool (for example a screwdriver).

The tightening screw is made of steel.

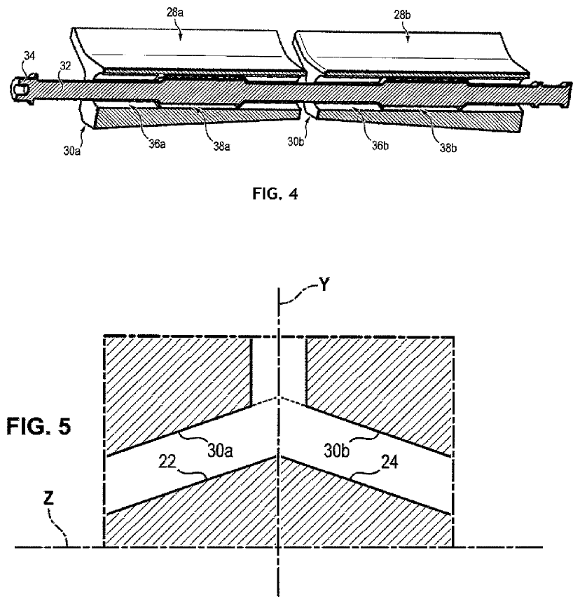

In reference to FIG. 4, the shims 26a, 26b define two through passages 36a, 36b in which the tightening screw 32 is engaged simultaneously.

For each shim the locking device also comprises a thread cooperating with the tightening screw 32 such that rotation of the tightening screw causes movement of the shim along the tightening screw 32.

The threads can be formed directly in the shims 26a, 26b. Yet, preferably and as illustrated in FIG. 4, the locking device comprises two sleeves 38a, 38b in which the two threads are formed. The sleeves 38a, 38b form rings which extend in the passages 36a, 36b between the tightening screw 32 and the shims (each sleeve enclosing a section of the tightening screw 32 and itself being enclosed by one of the shims).

The two threads cooperate with the tightening screw 32 such that rotation of the tightening screw 32 causes movement of the shim 26a relative to the other shim 26b along the tightening screw 32. For this purpose, it is possible to provide in the tightening screw 32 two different sections having threads of opposite direction cooperating respectively with the threads of the sleeves 38a, 38b. Therefore, when the tightening screw 32 is set in rotation in a first direction (or tightening direction), the two shims 26a, 26b move towards each other, and when the tightening screw 32 is set in rotation in a second direction (or untightening direction) opposite the first direction, the two shims 26a, 26b move away from each other.

Each shim 26a, 26b comprises means for axially blocking the sleeve in the axis of the corresponding passage wherein it is housed. These axial blocking means comprise for example stop beads 320, on the screw 32, provided to be engaged in an axial stop 220 projecting into the pocket 10. Therefore, when the tightening screw 32 is set in rotation relative to a shim, the shim shifts along the axis of the tightening screw 32 relative to the latter.

Once the tightening screw 32 is coupled with the shims 26a, 26b, the respective first support surfaces 28a, 28b of the two shims 26a, 26b are parallel to each other and aligned so that they can bear simultaneously on a free cylindrical surface of a blade root.

The second support surfaces 30a, 30b also have different slopes.

The second support surface 30a and the base surface with which it is in contact when the shim is in the pocket 10, for example the base surface 20, have a slope in common.

Similarly, the second support surface 30b and the base surface with which it is in contact when the shim is in the pocket 10, for example the base surface 22, have a slope in common.

The second support surfaces 30a, 30b and the base surfaces 22, 24 can have different sagittal profiles.

In a first embodiment illustrated in FIG. 5, the second support surfaces 30a, 30b have a rectilinear sagittal profile and the base surfaces 22, 24 have also a rectilinear sagittal profile.

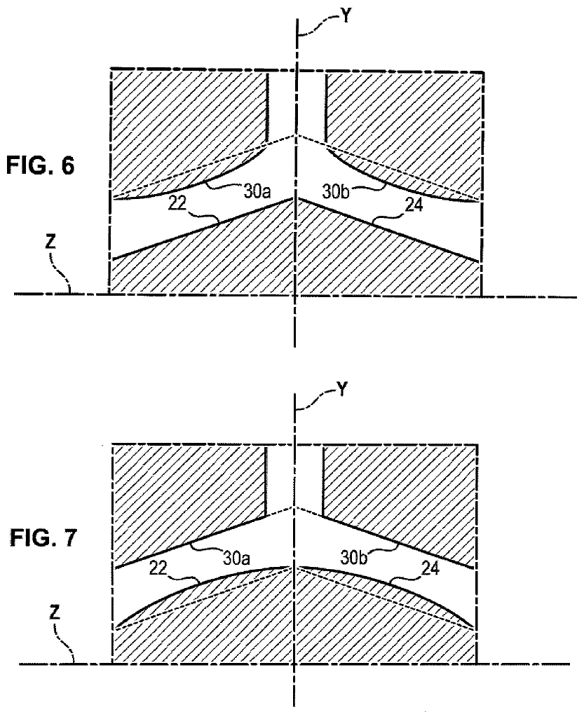

In a second embodiment illustrated in FIG. 6, the second support surfaces 30a, 30b have a convex curved sagittal profile and the base surfaces 22, 24 also have a rectilinear sagittal profile.

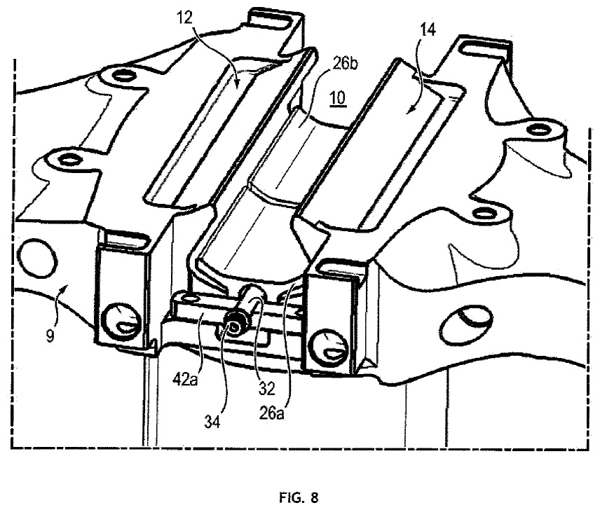

In a third embodiment illustrated in FIG. 7, the second support surfaces 30a, 30b have a rectilinear sagittal profile and the base surfaces 22, 24 have also a convex curved profile.

Relative to the first embodiment, the second embodiment and the third embodiment have the advantage of avoiding the occurrence of over-centre locking of one of the shims during its movement in the pocket 10, which would prevent the shim from adopting a stable position letting it exert an appropriate force on the blade root.

Relative to the third embodiment the second embodiment has the advantage of being easy to manufacture.

In the three preceding embodiments, the base of the pocket 10 is overall convex. In this case, the two base surfaces 22, 24 together form a protuberance and are connected to each other in a line forming an apex of the protuberance.

Referring again to FIG. 2, the locking device also comprises two locks 40a, 40b arranged to prevent each shim 26a, 26b from exiting from the pocket 10 via the opposite accesses 26, 18.

The tightening screw passes through two locks 40a, 40b.

The locks 40a, 40b are dimensioned to at least partially obstruct the two access 16, 18 opposite the pocket 10.

The lock 40a comprises two parts: a lower part 42a and an upper part 44a.

The lower part 42a partially defines a through passage for the tightening screw 32. The upper part 44a also partially defines this same passage. The through passage of the lock 40a is formed by assembling of its two parts 42a and 42b.

The lock 40b comprises two parts: a lower part 42b and an upper part 44b similar to the parts 42a and 44a.

The through holes defined by the locks 40a, 40b and which the tightening screw 32 pass through are preferably of dimensions adapted to allow radial play of the screw 32, that is, the screw 32 engaged in one of these passages can shift slightly in a direction parallel to the axis Y, relative to the corresponding lock 40a or 40b.

The locks 40a, 40b can be made of titanium or steel according to their thickness.

The head 34 of the tightening screw 32 terminates outside the pocket 10 and the locking device (especially outside the locks 40a, 40b) so that it can be clamped and set in rotation by a tool, when the shim is received in the pocket 10.

The locking device also comprises fastening means of each lock 40a, 40b to the fastener 9.

These fastening means comprise for example fixing screws 46a, 46b (typically two per lock) and threaded holes in the locks and in the fastener, threaded holes wherein fixing screws 46a, 46b are received.

The locking device can also comprise an anti-rotation system (not illustrated) preventing the tightening screw from being set in rotation in a direction causing a decrease in force exerted by the clamping device on the root. The anti-rotation system can for example comprise a pin capable of being passed radially through the tightening screw 32, or also even one of the locks 40a, 40b, to block the tightening screw in rotation 32 relative to the fastener 9 and/or to one of the locks 40a, 40b.

Assembling the fastener 9, a blade, and the clamping device comprises the following steps.

The assembly formed by the shims 26a, 26b and the tightening screw 32 is inserted into the pocket 10 via any one of the two opposite accesses defined by the fastener 9 such that the second support surfaces 30a, 30b of the two shims 26a, 26b rest respectively on the two base surfaces of the pocket 10.

The lower parts 42a, 42b of the locks 40a, 40b are then placed between the tightening screw 32 and the fastener 9, in front of each of the two opposite accesses 16, 18 (see FIG. 8), by slightly raising the tightening screw 32.

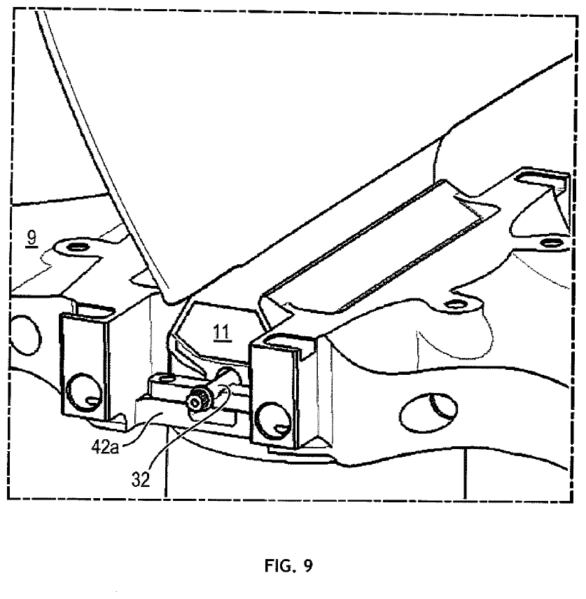

A blade root 11 is then engaged in the pocket 10 via one of the two opposite accesses 16, 18 in the direction Z such that the blade root 11 rests on the first support surfaces 28a, 28b of the shims 26a, 26b. Once positioned in the pocket 10, the blade passes through the upper passage of the pocket 10 made between the two flanks of the fastener. The blade root 11 has a dovetail form allowing it to be blocked radially in the pocket 10 parallel to the radial axis Y by the flanks 12, 14 (see FIG. 9) by promoting the blade being held centrifugally.

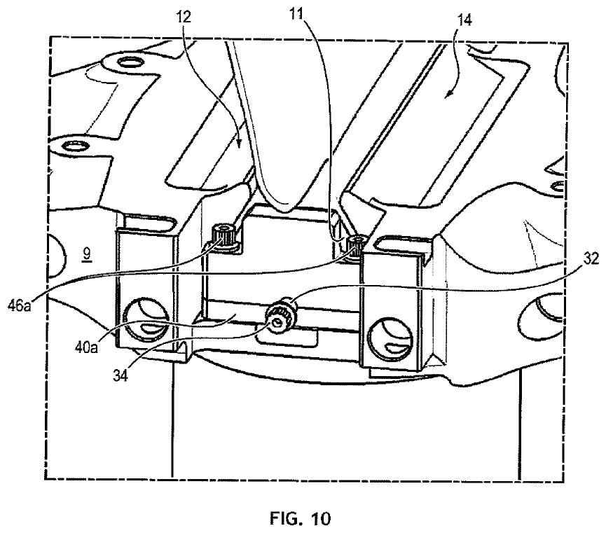

The two upper parts 44a, 44b of the locks are then placed on the lower parts 42a, 42b of thee locks. The locks 40a, 40b are fixed to the fastener by means of fixing screws (see FIG. 10).

The two locks 40a, 40b formed in this way prevent the shims 26a, 26b, or even the blade root 11, from exiting from the pocket 10 via the two opposite accesses.

The tightening screw 32 is set in rotation by means of a tool clamped by the head 34 in a first direction (tightening direction). This rotation causes the two shims 40a, 40b to move together reciprocally in the axis of the screw (parallel to the axis Z of the pocket 10) since the sleeves 38a, 38b with which the tightening screw 32 cooperates are blocked axially relative to the shims 26a, 26b. At the same time, due to the slopes of the second support surfaces 30a, 30b and the base surfaces 22, 24, the shims 26a, 26b exert force on the blade root 11 in a radial direction parallel to the axis Y, such that the blade root 11 is clamped between the two flanks and the shims. As the tightening screw is turned in the first direction, the value of the force impressed by the shims 26a, 26b on the blade root 11 is increased.

Similarly, when the tightening screw 32 is set in rotation in a second direction opposite the first direction (direction of untightening), this rotation causes the two shims 26a, 26b to move apart reciprocally. At the same time, due to the slopes of the second support surfaces 30a, 30b and the base surfaces 22, 24, the force exerted on the blade root 11 by the shims 26a, 26b in the radial direction is decreased.

Finally, the accumulated force exerted by the two shims 26a, 26b on the blade root 11 is a function of the following parameters:
the profiles of the second support surfaces 30a, 30b and of the base surfaces 22, 24,
the pitch of the screw 32,
the value of coefficients of friction between the tightening screw 32 and the sleeves 38a, 38b, and between the shims 26a, 26b and the fastener 9.

In the embodiments described hereinabove, the locking device is not obligatory even though it is advantageous to prevent the shims 26a, 26b from exiting from the pocket 10 during tightening. In fact, once the shims 26a, 26 are positioned in the pocket they move more closely together during tightening so much so that such exiting can be avoided (provided no excessive untightening is undertaken).

The presence of two shims is also not obligatory, even though it is advantageous as it distributes the overall clamping force exerted on the blade root 11 more evenly.

The sleeves 38a, 38b are optional as the threads cooperating with the tightening screw 32 can be formed directly in the shims 26a, 26b. A single shim can be provided, rather than two.

Only one of the shims 26a, 26b can cooperate with the tightening screw 32 via a thread, whereas the other shim can be blocked axially relative to the tightening screw. Therefore, the presence of two threads which cooperate with the tightening screw 32 is not more obligatory. A single thread can suffice.

In the embodiments illustrated, the base of the pocket 10 is overall convex, so much so that the shims (when there are two of them) move together during tightening. As a variant, it can be possible for the base surfaces 22, 24 to jointly form a concavity at the base of the pocket 10, such that an increase of the clamping force exerted by the shims on the blade root 11 occurs when the two shims are moved away from each other.

1-12. (canceled)

13. An assembly comprising:
a fastener defining a pocket for receiving a root of a turbomachine blade, the fastener comprising two flanks defining between them a passage leading into the pocket and forming stops preventing the root from exiting from the pocket via the passage,
two shims including a first shim and a second shim, each of the two shims comprising:
a first support surface to bear on the root,
a second support surface opposite the first support surface to bear against the fastener when the shim is received in the pocket,
a thread,
wherein the first support surface and the second support surface of each of the two shims are:
fixed relative to each other,
oriented such that movement of the first shim in the pocket relative to the second shim varies a sum of forces exerted by the two shims on the root,
a tightening screw cooperating with the thread of each of the two shims such that rotation of the tightening screw causes movement of the first shim relative to the second shim.

14. The assembly according to claim 13, wherein the fastener has a base surface against which the second support surface of the first shim bears when the first shim is received in the pocket, and wherein a surface from among the second support surface and the base surface has a rectilinear profile from among the second support surface and the base surface in a plane parallel to a direction of insertion of the root in the pocket, and the other surface has a convex curved profile in said plane.

15. The assembly according to claim 14, wherein the surface having a convex curved profile is the second support surface.

16. The assembly according to claim 13, further comprising a locking device configured to lock at least one of the two shims in different positions relative to the fastener, the sum of the forces exerted by the two shims on the root having different values in the different positions.

17. The assembly according to claim 16, wherein the locking device comprises the tightening screw and the thread of each of the two shims.

18. The assembly according to claim 17, wherein the locking device comprises a sleeve in which one of the threads is formed, wherein at least the first shim defines a cavity containing a sleeve in which one of the threads is formed, the cavity being adapted for blocking the sleeve relative to the first shim in a direction parallel to an axis of rotation of the tightening screw and for allowing some play of the sleeve relative to the first shim in a radial direction relative to the axis of rotation of the tightening screw.

19. The assembly according to claim 17, wherein the locking device comprises an anti-rotation system preventing the tightening screw from being set in rotation in a direction causing a decrease in the sum of the forces exerted by the two shims on the root.

20. The assembly according to claim 17, wherein the tightening screw comprises a head arranged to terminate outside the pocket and the locking device so that it can be clamped and set in rotation by a tool, when the two shims are received in the pocket.

21. The assembly according to claim 17, wherein the fastener defines two opposite accesses allowing introduction of the root and the two shims in the pocket, and wherein the locking device comprises two locks which the tightening screw passes through, the locks being arranged to prevent the two shims from exiting from the pocket via the opposite accesses when the tightening screw is set in rotation.

22. The assembly according to claim 13, wherein the fastener has two base surfaces against which the respective second support surfaces of the two shims bear when the two shims are received in the pocket, wherein the second support surfaces have different slopes, and wherein the base surfaces have different slopes.

23. The assembly according to claim 13, wherein at least one of the two shims is made of a metal.

24. The assembly according to claim 23, wherein the metal is titanium.

25. An unducted fan comprising an assembly according to claim 13.

26. The unducted fan according to claim 25, wherein the unducted fan has a variable pitch.
